(19) United States
(12) Patent Application Publication
(10) Pub. No.: US 2007/0193401 A1
(43) Pub. Date: Aug. 23, 2007

(54) Accelerator pedal for a vehicle

(75) Inventor: Andrew Campbell, Glasgow (GB)

Correspondence Address: CTS CORPORATION, 905 W. BLVD. N, ELKHART, IN, 46514, US

(73) Assignee: CTS Corporation

(21) Appl. No.: 11/636,202

(22) Filed: Dec. 8, 2006

Related U.S. Application Data
(60) Provisional application No. 60/764,693, filed on Feb. 2, 2006.

(51) Int. Cl. G05G 1/14

(52) U.S. Cl. 74/560

(57) ABSTRACT

A pedal assembly for mounting to the floor of a vehicle. The pedal assembly includes a housing and a pedal arm that is coupled to the housing. A friction generating assembly is coupled with the pedal arm. A sensor is coupled to the friction generating assembly. The sensor is responsive to the movement of the pedal arm to provide an electrical signal that is representative of pedal arm displacement.

### CROSS-REFERENCE TO RELATED AND CO-PENDING APPLICATIONS

This application claims priority to the filing date of U.S. Provisional Patent Application Ser. No. 60/764,693, filed on Feb. 2, 2006, entitled, “Floor Mounted Pedal and Sensor Assembly”, the contents of which are explicitly incorporated by reference in entirety.

### FIELD OF THE INVENTION

This invention relates to a pedal mechanism. In particular, the pedal may be an accelerator pedal in a vehicle.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduce the foot pressure required from the driver to hold a given throttle position. Likewise, friction prevents road bumps felt by the driver from immediately affecting throttle position.

Efforts are underway to replace the mechanical cable-driven throttle systems with a more fully electronic, sensor-driven approach. With the fully electronic approach, the position of the accelerator pedal is read with a position sensor and a corresponding position signal is made available for throttle control. A sensor-based approach is especially compatible with electronic control systems in which accelerator pedal position is one of several variables used for engine control.

Although such drive-by-wire configurations are technically practical, drivers generally prefer the feel, i.e., the tactile response, of conventional cable-driven throttle systems. Designers have therefore attempted to address this preference with mechanisms for emulating the tactile response of cable-driven accelerator pedals. For example, U.S. Pat. No. 6,360,631 Wortmann et al. is directed to an accelerator pedal with a plunger subassembly for providing a hysteresis effect.

In this regard, prior art systems are either too costly or inadequately emulate the tactile response of conventional accelerator pedals. Thus, there continues to be a need for a cost-effective, electronic accelerator pedal assembly having the feel of cable-based systems.

### SUMMARY

In one embodiment, the present invention provides a pedal assembly. The pedal assembly includes a housing and a pedal arm coupled to the housing. A friction generating assembly is coupled with the pedal arm. A sensor is coupled to the friction generating assembly. The sensor is responsive to the movement of the pedal arm to provide an electrical signal that is representative of pedal displacement.

In another embodiment, the present invention provides a pedal assembly. The pedal assembly includes a housing and a pedal arm coupled to the housing. A first arm is coupled to the pedal arm. A second arm is coupled to a magnet assembly. A brake pad is coupled between the first arm and the second arm. A position sensor is coupled to the housing and is positioned in proximity to the magnet assembly. The sensor is responsive to the movement of the pedal arm to generate an electrical signal that represents pedal displacement.

These and other objects, features and advantages will become more apparent in light of the text, drawings and claims.

### BRIEF DESCRIPTION OF THE DRAWINGS

FIG. 1 is an exploded isometric view of the accelerator pedal assembly of the present invention.

FIG. 2A is an enlarged assembled cross-sectional view of the accelerator pedal assembly shown in FIG. 1 with the pedal in a non-depressed state.

FIG. 2B is an enlarged assembled cross-sectional view of the accelerator pedal assembly shown in FIG. 1 with the pedal in a depressed state.

FIG. 3 is an assembled isometric view of the accelerator pedal assembly shown in FIG. 1 with the cover removed.

FIG. 4 is an isometric view of a magnet assembly.

FIG. 5 is an isometric view of a brake pad.

FIG. 6 is a cross-sectional view of the of the accelerator pedal assembly showing the brake pad engaging the braking surface.

FIG. 7 is a top view of a magnet.

FIG. 8 is a side view of a magnet.

FIG. 9 is a bottom view of a magnet.

FIG. 10 is another side view of a magnet.

FIG. 11 is an isometric view of a magnet.

### DETAILED DESCRIPTION

While this invention is susceptible to embodiment in many different forms, this specification and the accompanying drawings disclose several forms as examples of the invention. The invention is not intended to be limited to the embodiments so described, however. The scope of the invention is identified in the appended claims.

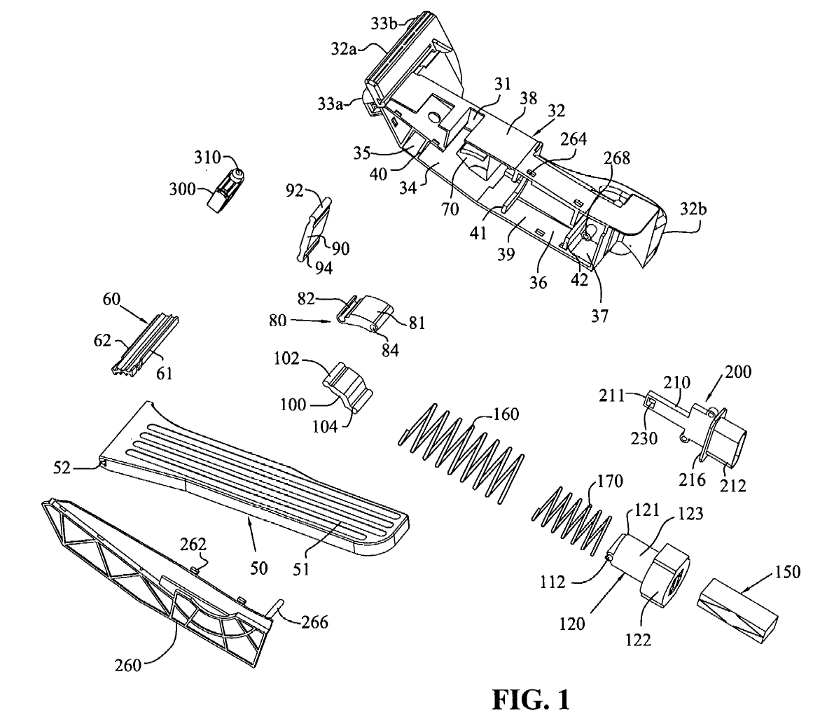

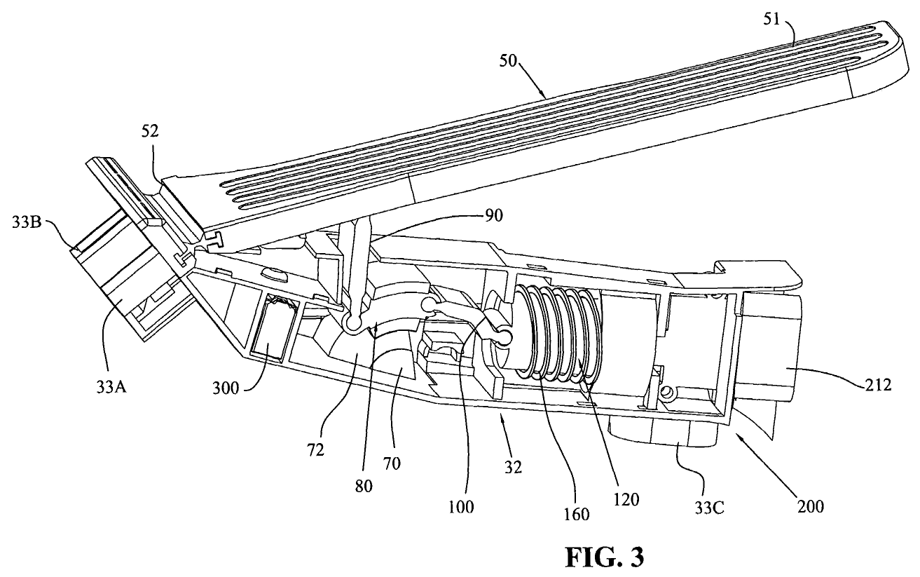

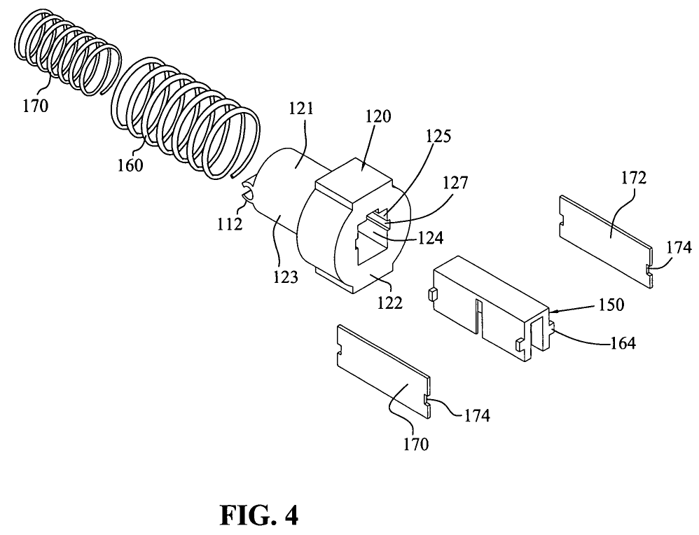

Referring to FIGS. 1-6, a non-contacting accelerator pedal assembly 20 according to the present invention includes a housing 32 and a pedal arm 50 that is rotatably mounted to housing 32. Housing 32 can contain the components of the pedal assembly. Housing 32 would typically be mounted to a floor of a vehicle. Housing 32 can be formed from molded plastic. Housing 32 can include mounting points 33A, 33B and 33C.

Housing 32 can include several cavities. The cavities include brake pad cavity 34, a kickdown cavity 35, a magnet cavity 36 and a connector cavity 37. Housing 32 has ends, 32A, 32B, an upper wall 38, lower wall 39 and slot 33. A wall 40 separates cavities 34 and 35. A wall 41 separates cavities 34 and 36. A wall 42 separates cavities 36 and 37. Housing 32 has a T-shaped hinge slot 44.

A cover 260 that encloses the cavities can cover housing 32. Cover 260 has tabs 262 that snap-fit and mate with holes 264 of housing 32. An alignment pin 266 extends from cover 260 and fits into hole 268 of cover 32. Cover 260 further has a rounded ½ v-shaped portion 270 (FIG. 6) that extends from cover 260. Portion 270 has a braking surface 272.

Pedal arm 50 has a footpad 51 and a T-shaped hinge slot 52 at one end. Footpad 51 is adapted to be depressed by the foot of a vehicle driver. Pedal arm 50 further has an elongated ball socket 54, a protrusion 55 and ridge 57. A flexible hinge 60 has T-shaped ends 61 and 62. Hinge 60 can be made from a flexible material such as rubber or plastic. End 61 is retained in hinge slot 52 and end 62 is retained in hinge slot 44. Hinge 60 retains pedal arm 50 to housing 32 and allows pedal arm 50 to bend and pivot about an axis of rotation 65.

A kickdown device 300 can be mounted in kickdown cavity 35. Kickdown device 300 can include a button 310. Button 310 is contacted by protrusion 55 when pedal arm 50 is sufficiently depressed. Kickdown device 300 provides an increased resistance to pedal depression at a certain point in the depression of pedal arm 50.

Details of the use and construction of kickdown device 300 can be found in U.S. Pat. No. 6,418,813, entitled, “Kickdown Mechanism for a Pedal”. The contents of which are herein incorporated by reference in entirety.

A rounded half drum portion 70 that presents a curved, convex braking (or drag) surface 72 is mounted to wall 38 in cavity 34. Braking surface 72 can have a curvature. Braking surface 72 can have a ½ v-shape. A non-circular curvature for the braking surface is also contemplated. In one embodiment, surface 72 is curved and convex with a substantially constant radius of curvature. In alternate embodiments, surface 72 has a varying radius of curvature. Braking surfaces 72 and 272 can be chosen from a material that generates a desired coefficient of friction.

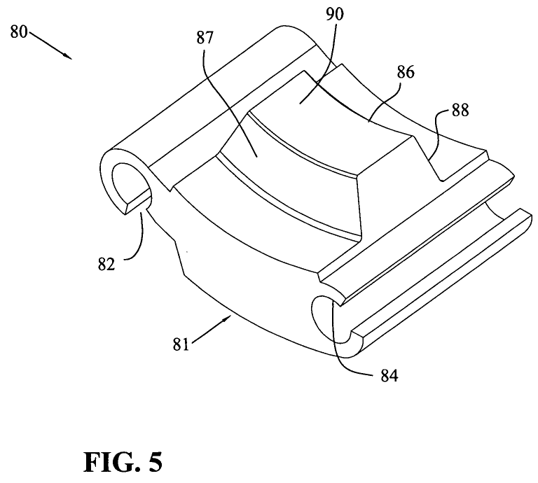

With specific reference to FIGS. 5 and 6, a braking or friction generating assembly 80 includes a brake pad 81 is that is mounted between arms 90 and 100. Brake pad 80 has elongated ball sockets 82, 84 on each end of the brake pad and a contact surface. 86. Brake pad 80 has a contact surface 86 that includes surfaces 87, 88 and 89. Contact surface 86 is mounted adjacent braking surface 72 and is urged against braking surface 72 as the pedal arm 50 is depressed. Contact surface 86 can have a partial v-shape. The v-shape of contact surface 86 contacts braking surfaces 72 and 272. Surface 88 contacts braking surface 272 and surface 72 contacts surface 87. The ½ v-shape of braking surface 272 and surface 72 are positioned adjacent each other and form a complete v-shape after cover 260 is mounted to housing 32.

Arm 90 includes a ball joint 92 at one end and ball joint 94 at another end. Ball joint 92 is pivotally retained in socket 54. Ball joint 94 is pivotally retained in socket 82. The ball joints and sockets allow arm 90 to pivot and rotate. The ball joints are assembled by sliding the ball joints into the sockets.

Arm 100 includes a ball joint 102 at one end and ball joint 104 at another end. Ball joint 102 is pivotally retained in socket 84. Ball joint 104 is pivotally retained in socket 112. The ball joints and sockets allow arm 100 to pivot and rotate Arm 100 is connected to magnet holder 120 through ball joint 104 and socket 112. Magnet subassembly 140 includes magnet holder 120 and magnet 130. Magnet 130 creates a variable magnetic field that is detected by Hall effect sensor 150. Acting together, magnet 130 and sensor 150 provide an electrical signal that is representative of the pedal displacement.

Magnet holder 120 includes ends 121, 122, an outer surface 123, inner surface 124, cavity 125, and an annular grove 126. Slots 127 are located inside cavity 125. Magnet 150 is mounted inside cavity 125. Socket 112 is mounted to end 121.

A pair of concentric coil springs 160 and 170 are mounted around magnet holder 120 and inside cavity 39. Spring 170 is located inside spring 160. Springs 160 and 170 are compressed between wall 41 and magnet holder 120. One end of springs 160 and 170 rest in groove 126. Springs 160 and 170 bias magnet holder toward end 32B and also cause pedal arm 50 to move away from housing 32. Two springs are used for redundancy reasons. If one spring were to fail, another would still be operational. This redundancy is provided for improved reliability, allowing one spring to fail or flag without disrupting the biasing function. It is useful to have redundant springs and for each spring to be capable—on its own—of returning the pedal arm to its idle position. Other types of springs could also be used such as leaf springs or torsion springs.

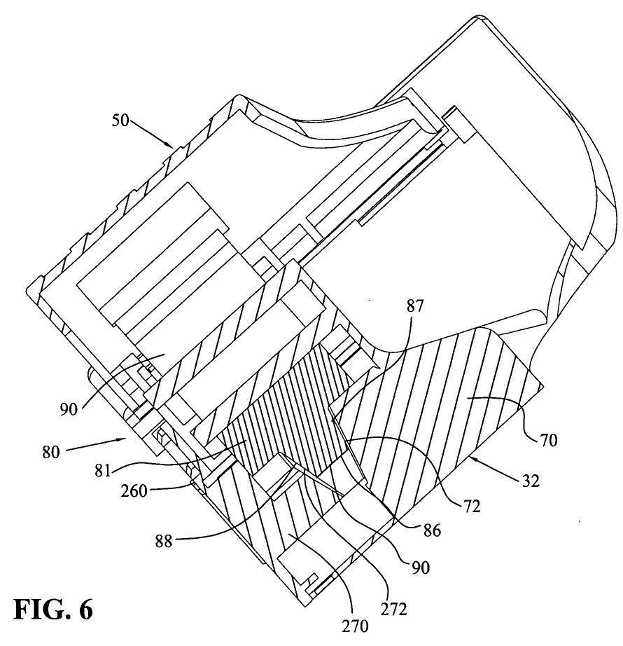

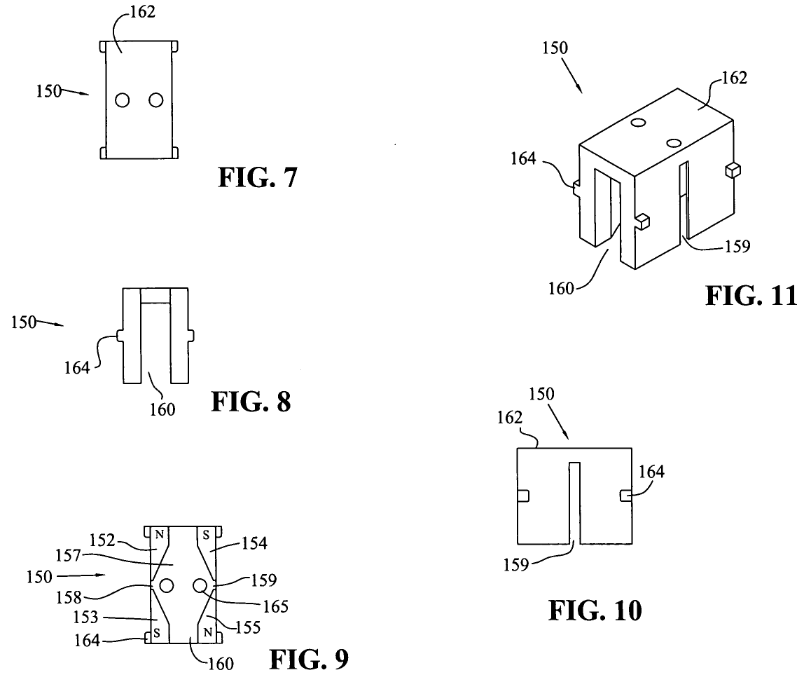

Magnet 150 can be a bi-polar tapered magnet as shown in FIGS. 7-11. Magnet 150 has four magnet portions 152, 153, 154 and 155. Magnet portions 152 and 155 have a north polarity and portions 153 and 154 have a south polarity. The magnet portions are sloped such that a diamond shaped air gap 157 is formed between the magnet portions. The sloped magnet portions create a variable flux density magnetic field in air gap 157. Magnet 150 further has slots 158 and 159 and a central opening 160. Magnet 150 also has a back surface 162, tabs 164 and holes 165. Magnet 150 can be formed from molded ferrite. Details of the use and construction of magnet 150 can be found in U.S. Pat. No. 6,211,668, entitled, “Magnetic Position Sensor Having Opposed Tapered Magnets”, the contents of which are herein incorporated by reference in entirety.

With specific reference to FIG. 6, a pair of magnetic field conductors or steel pole pieces 170 and 172 can be mounted to each side of magnet 150. Pole pieces 170 and 172 assist in guiding the flux generated by magnet 150.

Pole pieces 170 and 172 have recesses 174. Tabs 164 can extend through recesses 174 after mounting. When magnet 150 is placed into cavity 125, tabs 164 slide into slots 127 and guide magnet 150. Magnetic field conductors 170 and 172 provide a low impedance path for magnetic flux to pass from one pole of the magnet to another.

Turning to FIGS. 1-3, sensor assembly 200 is mounted to housing 32 in proximity of and to interact with magnet assembly 140. Sensor assembly 200 includes a printed circuit board portion 210 that has an attached connector 212. Connector 212 can have terminals 214 for receiving a wiring harness connector plug (not shown) that would connect to an engine controller in a vehicle. Connector 212 can have a flange 216 that can be ultrasonically welded to housing 32 to retain the connector to the housing.

Circuit board 210 carries a Hall Effect sensor 230. Hall effect sensor 230 is responsive to flux changes induced by pedal arm displacement and corresponding motion of brake pad 80 and magnet assembly 140. More specifically, printed circuit board 210 has an end 211 that extends into air gap 157. Hall effect sensor 230 is mounted toward end 211. Hall effect sensor 230 measures a variable magnet flux that is generated by magnets 152-155 and passes through airgap 157.

Hall effect sensor 230 is operably connected via circuit board 210 to connector 212 for providing an electrical signal to an engine controller or computer. More than one Hall effect sensor may be used. Two Hall sensors allow for comparison of the readings between the two Hall effect sensors and consequent error correction. In addition, each sensor can serve as a back up to the other should one sensor fail.

Electrical signals from sensor assembly 200 have the effect of converting displacement of the foot pedal 50, as indicated by displacement of the magnet 150, into a dictated speed/acceleration command which is communicated to an electronic control module such as is shown and described in U.S. Pat. No. 5,524,589 to Kikkawa et al. and U.S. Pat. No. 6,073,610 to Matsumoto et al. hereby incorporated expressly by reference.

Pedal arm 50 can have predetermined operational limits in the form of an idle, return position stop and a depressed, open-throttle position stop. When pedal arm 50 is fully depressed, ridge 57 comes to rest against side 38 of housing 32 and thereby limiting movement of arm 50. When pedal arm 50 is fully released, magnet holder 120 comes to rest against wall 42 of housing 32 and thereby limiting movement of arm 50.

Housing 32 is securable to a floor of a vehicle through fasteners or snap-fit devices using mounting points 33A, 33B and 33C. Pedal assemblies according to the present invention could also be used to mount to a firewall or pedal rack by means of an adjustable or non-adjustable position pedal box rack with minor changes to the housing design.

### Operation

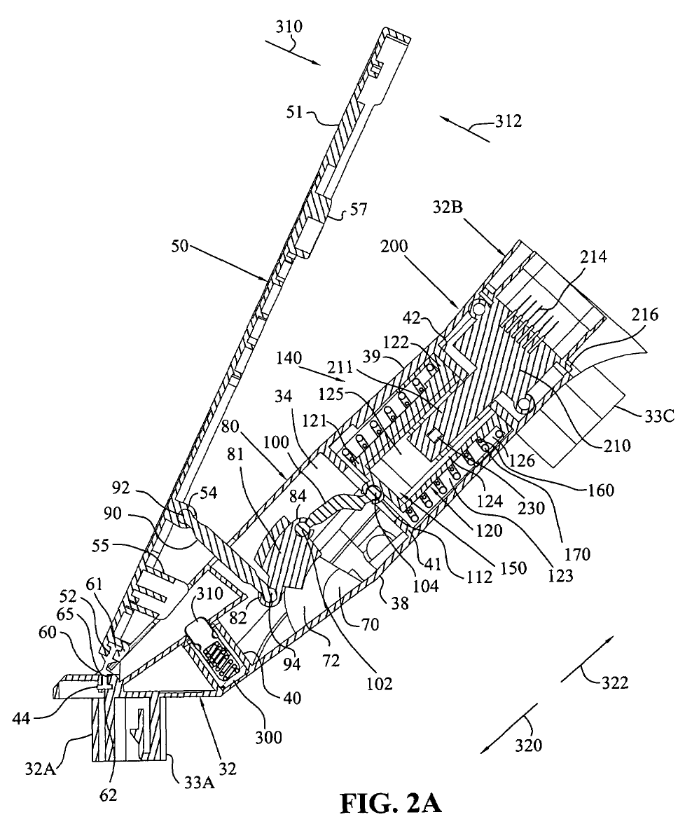

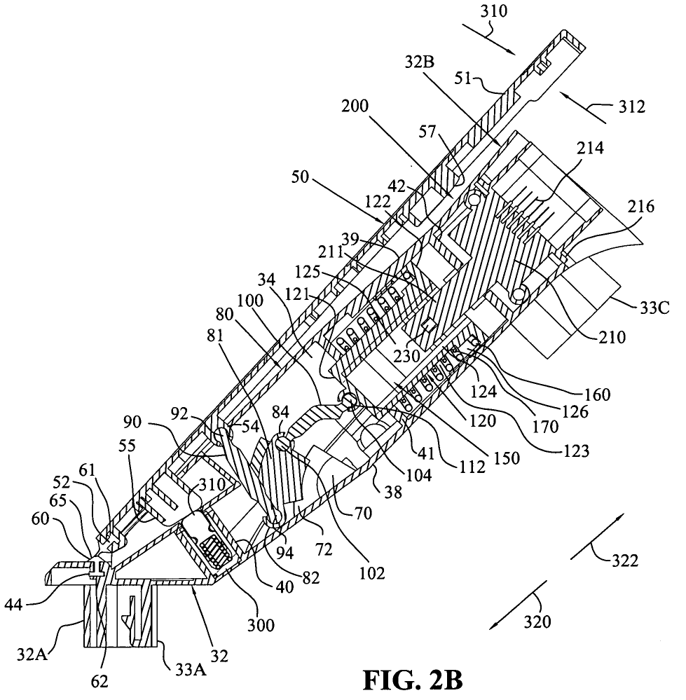

Referring now to FIGS. 2A and 2B, pedal arm 50 can move in a first direction 310 (accelerate) or the other direction 312 (decelerate). FIG. 2A shows pedal arm 50 in a non-depressed state and FIG. 2B shows pedal arm 50 fully depressed. As pedal arm 50 is depressed and moves in direction 310, arm 90 moves downwardly and forces contact surface 86 of brake pad 81 into increased frictional contact with both of braking surfaces 72 and 272 (best seen in FIG. 6). The resulting drag between braking surface 86 and contact surfaces 72 and 272 is felt by the person depressing pedal arm 50 as an increased force or resistance as the pedal is depressed.

As pedal arm 50 moves in direction 310, arm 100 is also moved due to it being connected to brake pad 81. Movement of arm 100 causes magnet holder 120 to move linearly inside cavity 36 in direction 320. End 321 will move from being in cavity 36, (FIG. 2A), past wall 41 to being in cavity 34 (FIG. 2B). As magnet holder 120 moves in direction 320, springs 160 and 170 are compressed. Movement of magnet holder 120 causes movement of magnet 150 relative to the hall effect device 170 that is fixed in position. The movement of magnet 150 causes the flux field passing through hall effect device 170 to change in magnitude and polarity. This variation in flux magnitude and polarity is sensed by Hall effect device 170. Hall effect device 170 generates an electrical signal that is proportional to the flux magnitude and polarity. This electrical signal is provided to an engine controller at terminals 214.

As pedal arm 50 moves further in direction 310, protrusion 55 contacts button 310 of kickdown device 300 and pushes in on button 310 causing compression of the spring in kickdown device 300. The movement of button 310 is felt by the person depressing pedal arm 50 as a further increase in force or resistance as the pedal is depressed. Pedal arm 50 is now fully depressed as shown in FIG. 2B.

When pedal force on arm 50 is reduced, pedal arm 50 moves in direction 312. Compressed springs 160 and 170 decompress and urge brake pad 81 and magnet holder in direction 322. The resulting drag between braking surface 86 and contact surfaces 72 and 272 slows the movement in direction 312 of pedal arm 50 and can be felt by the person touching pedal arm 50. Further reduction in force on pedal arm 50 results in springs 160 and 170 being fully decompressed and magnet holder 120 resting on wall 42. This position would correspond to an idle engine condition as shown in FIG. 2A.

The effect of the depression of the pedal arm 50 leads to an increasing normal force exerted by the contact surfaces 72 and 272 against braking surface 86. A friction force between the surfaces 72 and 272 and surface 86 is defined by the coefficient of dynamic friction multiplied by the normal force. As the normal force increases with increasing applied force at the pedal arm, the friction force accordingly increases. The driver feels this increase in his/her foot at pedal arm 50. The friction force opposes the applied force as the pedal is being depressed and subtracts from the spring force as the pedal is being returned toward its idle position.

It is noted that while a magnet and hall effect sensor were used to detect the position of the pedal, other types of sensors could also be used such as linear or rotary resistive position sensors, capacitive sensors and inductive sensors.

Numerous variations and modifications of the embodiments described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

What is claimed is:

1. A pedal assembly comprising:
a housing;
a pedal arm coupled to the housing;
a first arm coupled to the pedal arm;
a second arm coupled to a magnet assembly;
a brake pad coupled between the first arm and the second arm;
a position sensor coupled to the housing and positioned in proximity to the magnet assembly, the sensor responsive to the movement of the pedal arm for providing an electrical signal representative of pedal displacement.

2. The pedal assembly in accordance with claim 1 wherein the housing has a braking surface and the brake pad has a contact surface that is substantially complementary to the braking surface, the brake pad being adapted to be engaged with the braking surface.

3. The pedal assembly in accordance with claim 1 wherein a spring device is situated between the magnet assembly and the housing for urging the pedal arm to a rest position.

4. The pedal assembly in accordance with claim 2 wherein the contact surface is substantially v-shaped.

5. The pedal assembly in accordance with claim 2 wherein the braking surface is substantially v-shaped.

6. The pedal assembly in accordance with claim 1 wherein the brake pad is coupled to at least one of the arms by a ball and socket.

7. The pedal assembly in accordance with claim 1 wherein a kickdown device is coupled to the housing.

8. The pedal assembly in accordance with claim 1 wherein the pedal arm is coupled to the housing by a hinge.

9. A pedal assembly comprising:
a housing;
a pedal arm coupled to the housing;
a friction generating assembly coupled with the pedal arm; and
a sensor coupled to the friction generating assembly, the sensor responsive to the movement of the pedal arm to provide an electrical signal that is representative of pedal displacement.

10. The pedal assembly in accordance with claim 9 wherein the friction generating assembly includes a brake pad having a contact surface and the housing having a braking surface, the brake pad being adapted to engage the braking surface as the pedal is depressed.

11. The pedal assembly in accordance with claim 10 wherein the brake pad is coupled to the pedal arm by a first arm.

12. The pedal assembly in accordance with claim 9 wherein the sensor includes a magnet assembly and a hall effect device positioned proximate the magnet assembly.

13. The pedal assembly in accordance with claim 10 wherein the sensor includes a magnet assembly, the magnet assembly being coupled to the brake pad.

14. The pedal assembly in accordance with claim 13 wherein a second arm couples the brake pad to the magnet assembly.

15. The pedal assembly in accordance with claim 13 wherein a spring device is situated between the magnet assembly and the housing for urging the pedal arm to a rest position.

16. The pedal assembly in accordance with claim 13 wherein the magnet assembly moves in a linear manner as the pedal arm is depressed.

17. A pedal assembly comprising:
housing means for containing the pedal assembly;
pedal arm means for allowing a user to depress the pedal arm, the pedal arm means coupled to the housing means;
brake means for generating friction when the pedal arm means is depressed, the brake means coupled with the pedal arm means; and
sensor means for sensing the position of the pedal arm means, the sensor means coupled to the brake means.

18. The pedal assembly in accordance with claim 17 wherein the brake means includes a brake pad having a contact surface and the housing means having a braking surface, the brake pad being adapted to engage the braking surface as the pedal is depressed.

19. The pedal assembly in accordance with claim 17 further comprising first arm means coupled between the brake means and the sensor means.

20. The pedal assembly in accordance with claim 17 further comprising second arm means coupled between the brake means and the pedal arm means.

21. The pedal assembly in accordance with claim 17 wherein the sensor means includes a magnet assembly and a hall effect device positioned proximate the magnet assembly.

22. A pedal assembly comprising:
a housing;
a pedal arm having a first end that can be moved and a second end that is rotatably coupled to the housing;
a friction generating device mounted in the housing and coupled to the pedal arm for changing the amount of force required to move the first end; and
a sensor mounted in housing and coupled to the friction generating device, the sensor being adapted to sense the position of the pedal arm and to provide an electrical signal that is indicative of the position of the pedal arm.

23. The pedal assembly in accordance with claim 22 wherein the pedal assembly is mounted to the floor of a vehicle.

24. The pedal assembly in accordance with claim 22 wherein a spring is situated between the sensor and the housing for urging the pedal arm to a rest position.

25. The pedal assembly in accordance with claim 22 wherein the friction generating device includes a brake pad having a contact surface and the housing having a braking surface, the contact surface being adapted to engage the braking surface as the pedal arm is depressed.

26. The pedal assembly in accordance with claim 25 wherein as the pedal arm is depressed, the contact surface of the brake pad is urged into increasing frictional engagement with the braking surface.

27. The pedal assembly in accordance with claim 22 wherein the sensor includes a magnet assembly and a hall effect device positioned proximate the magnet assembly.
